(19) United States
(12) Patent Application Publication
(10) Pub. No.: US 2023/0225362 A1
(43) Pub. Date: Jul. 20, 2023

(54) Aquatic-plant Protein Combined Restructured Meat and Preparation Method thereof

(71) Applicant: Jiangnan University, Wuxi (CN)

(72) Inventors: Yuanfa LIU, Wuxi (CN); Zhaojun ZHENG, Wuxi (CN); Liyang YUAN, Wuxi (CN)

(21) Appl. No.: 18/188,554

(22) Filed: Mar. 23, 2023

Related U.S. Application Data
(63) Continuation of application No. PCT/CN22/93830, filed on May 19, 2022.

(30) Foreign Application Priority Data
Dec. 21, 2021 (CN) 202111570903.X

(51) Int. Cl. A23J 3/22; A23J 1/04; A23J 3/16; A23J 3/14; A23J 3/04; A23J 3/34; A23L 33/185

(52) U.S. Cl. CPC A23J 3/227; A23J 1/04; A23J 3/16; A23J 3/14; A23J 3/04; A23J 3/346; A23J 3/341; A23L 33/185

(57) ABSTRACT

The present disclosure discloses an aquatic-plant protein combined restructured meat and a preparation method thereof, and belongs to the technical field of processing of foods. According to the present disclosure, a protein combined restructuring processing technology can be summarized as including pretreatment of an aquatic-plant protein, combined restructuring, high-temperature qualitative treatment, and integrated forming. The whole process is green, safe, and environmentally friendly. The protein combined restructured meat prepared contains two proteins including an animal protein and a plant protein, and has a protein content of greater than 20%. While the demands for nutritional dietary proteins are met, the chewability is greater than 1,500 g·mm, and the viscoelasticity is excellent. The meat can be processed in various shapes according to needs, directly heated for eating, or processed into a prepared food, a semi-finished product and the like, so that the product has a large application space.

### TECHNICAL FIELD

The present disclosure relates to an aquatic-plant protein combined restructured meat and a preparation method thereof, and belongs to the technical field of processing of foods.

### BACKGROUND

With the increasing improvement of the economic level and the living standard, the demands of residents for nutrition and health of foods are increasingly getting strong, and thus balanced diet nutrition has also become the focus of attention. High-nutrition and high-quality foods have become the goal that consumers are looking for. However, due to the influence of traditional life concepts or bad living habits, the situation of overnutrition or undernutrition is still obvious. Besides, the consumers don't have the time, money or interest to prepare high-nutrition foods from food ingredients by themselves. Therefore, it is urgent for the food industry to develop a new generation of processed foods, so as to meet the urgent needs of the consumers for easy use, low cost, nutrition and health.

As indispensable nutrients and key structural components in most foods, exogenous food proteins can effectively provide amino acids required for the growth and development of the human body, which are also the basis of synthesis of proteins in the human body. Combinations of proteins from different food sources have good gelation, a film-forming property and other surface functional properties as well as nutritional properties during application in the food industry. In particular, mixing of animal and plant proteins can improve properties of individual proteins and help to solve an environmental problem and a resource scarcity problem. However, at present, few kinds of foods about an animal and plant protein combination system are sold on the market, while dairy products, milk drinks and baked foods are mainly sold. Existing types of animal and plant protein combined foods are far from meeting the needs of the consumers for novel nutritious and healthy foods, resulting in many research and development gaps and development potential.

Aquatic products are high-quality protein resources, but need to be further improved in texture and functional properties. The mixing of the animal and plant proteins can improve the functional properties of products, and a protein restructuring processing technology has an obvious effect of improving the texture. In conclusion, the development of a novel nutritious and healthy combined restructured meat by the protein combined restructuring processing technology is helpful to improve the product quality, the sensory quality and nutritional and economic values.

### SUMMARY

### Technical Problems

In order to develop meat products with high nutrition and good flavor, an aquatic-plant protein meat is prepared by a combined restructuring processing technology with an aquatic animal meat and a plant protein as raw materials in the present disclosure. The restructured meat prepared by the method is a novel nutritious and healthy meat product or base material with high protein content, low fat content and good taste and flavor.

### Technical Solutions

A first object of the present disclosure is to provide a preparation method of an aquatic-plant protein combined restructured meat. The method mainly includes the following steps:

(1) preparation of an aquatic protein: defrosting an aquatic animal meat slice, conducting cutting and chopping, conducting soaking and cleaning in baking soda to obtain a meat pulp, and dewatering the meat pulp with a physical field to obtain an aquatic protein pulp;

(2) preparation of a plant protein: weighing a plant protein powder accounting for 5%-15% of the mass of the aquatic protein pulp obtained in step (1);

(3) uniform mixing and stirring: conducting mixing and stirring on the aquatic protein pulp obtained in step (1) and the plant protein powder obtained in step (2) until a homogeneous state is reached, and then obtaining a protein homogenate;

(4) pretreatment of a protein: adding a complex salt to the protein homogenate obtained in step (3) for pickling and rolling, adding a food-grade acid-base regulator for adjusting the pH so as to form a paste protein, and then obtaining the paste protein;

(5) combined restructuring: adding protease to the paste protein obtained in step (4), adding a natural small-molecule substance for crosslinking and restructuring of a protein, adding a color improver at the same time, conducting uniform mixing and stirring, and then conducting incubation in a water bath;

(6) high-temperature qualitative treatment: subjecting a product obtained in step (5) to inactivation and qualitative treatment in a high-temperature water bath, and then conducting cooling rapidly to room temperature; and

(7) integrated forming: conducting press forming on a sample obtained in step (6), or directly kneading the sample in the shape of a desired product to obtain the aquatic-plant protein combined restructured meat.

In one embodiment of the present disclosure, in step (1), the soaking and cleaning are conducted in 0.1-1.2% baking soda for 5-15 min to obtain a meat pulp.

In one embodiment of the present disclosure, in step (1), the aquatic animal meat is one or more of protein-rich tilapia mossambica, sole fishes, sardines, basa fishes or cod fishes, grass carps, and crucians or carps.

In one embodiment of the present disclosure, in step (1), the cutting and chopping include cutting and chopping the meat slice into evenly diced meats with a size of 0.5-1.5 cm, so as to facilitate subsequent mixing with a plant protein and provide convenience for controlling the dissolution degree of actomyosin.

In one embodiment of the present disclosure, in step (1), a physical field dewatering method includes dewatering by vacuum drying at a temperature of 60° C. and a pressure of 0.2 kPa.

In one embodiment of the present disclosure, in step (2), the plant protein powder is derived from one of soybeans, peas, black beans, mung beans, kidney beans, and chickpeas, and the plant protein powder is preferably derived from one of soybeans, mung beans, and chickpeas.

In one embodiment of the present disclosure, in step (2), the plant protein powder is obtained by extracting a plant protein using an alkali-solution and acid-isolation method and then conducting freeze-drying.

In one embodiment of the present disclosure, the alkali-solution and acid-isolation method specifically includes: degreasing a soybean powder; resuspending the soybean powder in deionized water; adjusting the pH of an obtained solution to 6.8-9.5 with NaOH, conducting stirring at room temperature for 0.5-4.5 h, conducting centrifugation at 4° C. to obtain a supernatant, and adding HCl for adjusting the pH to 2.0-6.0; repeating the above steps for 2-3 times; and washing an obtained precipitate with deionized water until the pH is 7.0.

In one embodiment of the present disclosure, in step (2), the plant protein powder is specifically and optionally a soybean protein isolate.

In one embodiment of the present disclosure, in step (3), the mixing mass ratio of the aquatic protein pulp to the plant protein is 30:1 to 1:1, preferably 20:1 to 10:1.

In one embodiment of the present disclosure, in step (3), the stirring is conducted at 4° C. for 10-40 min until a homogeneous state is reached.

In one embodiment of the present disclosure, in step (4), the complex salt is a complex of NaCl and phosphate, the added amount of the NaCl is controlled to be 0.5-1.5 wt % of the weight of the protein homogenate, such as 0.8 wt % specifically, and the added amount of the phosphate is 0-0.7 wt % of the weight of the protein homogenate, such as 0.4 wt % specifically.

In one embodiment of the present disclosure, in step (4), the pickling and rolling include stirring and rolling treatment in a rolling machine for 20-100 min.

In one embodiment of the present disclosure, in step (4), the pH is adjusted to 6.8-9.5.

In one embodiment of the present disclosure, in step (4), the food-grade acid-base regulator is one or more of malic acid, acetic acid, lactic acid, citric acid, sodium carbonate, sodium bicarbonate, and sodium lactate.

In one embodiment of the present disclosure, in step (5), the protease is one of glutamine transaminase, papain, bromerain, and flavourzyme, and has a concentration of 0.2-4.0 wt % of the weight of the paste protein.

In one embodiment of the present disclosure, in step (5), the natural small-molecule substance is one of epigallocatechin gallate (EGCG), genipine, resveratrol, curcumin, and rosmarinic acid, and the added amount is 0.02-0.20 wt % of the weight of the paste protein.

In one embodiment of the present disclosure, in step (5), the color improver includes sorghum red, beet red, monascus red, lycopene, allura red, carmine cochineal, and other red pigments, and the added amount is 0.01-0.75 wt ‰ of the weight of the paste protein.

In one embodiment of the present disclosure, in step (5), the treatment in the water bath is conducted at a temperature of 35-60° C. for 30-300 min.

In one embodiment of the present disclosure, in step (5), the protease has an enzyme activity of 1.5-30 units/mg.

In one embodiment of the present disclosure, in step (6), the high-temperature qualitative treatment includes subjecting a protein combined restructured meat obtained in step (5) to inactivation and qualitative treatment in a high-temperature water bath at 80-90° C. for 5-15 min, and then conducting cooling rapidly to room temperature in an ice bath.

In one embodiment of the present disclosure, in step (7), the formed protein combined restructured meat is required to be refrigerated at a low temperature of 4° C.; and when not being used in time, the sample is required to be refrigerated at −80° C. to −20° C.

A second object of the present disclosure is to provide an aquatic-plant protein combined restructured meat prepared by the process of the present disclosure.

A third object of the present disclosure is to provide application of the aquatic-plant protein combined restructured meat of the present disclosure in the field of manufacturing of health foods and food ingredients.

### Beneficial Effects

Compared with the prior art, the aquatic-plant protein combined restructured meat provided by the present disclosure has the following advantages.

(1) The present disclosure relates to an aquatic-plant protein combined restructured meat and a preparation method thereof. An aquatic protein and a plant protein are selected as raw materials, which are natural, green, nutritious, high in safety, and wide and abundant in source. A protein combined restructuring processing technology can be summarized as including pretreatment of an aquatic-plant protein, combined restructuring, high-temperature qualitative treatment, and integrated forming. The whole process is green, safe, and environmentally friendly. Large and complex equipment is not required, and the operation is simple. An enzyme and a natural small-molecule substance used are easy to obtain. A product of the prepared aquatic-plant protein combined restructured meat is expected to be produced in a large scale. A good foundation is laid for high-value utilization of animal and plant protein resources.

(2) According to a protein pretreatment method used in the present disclosure, a complex salt is added for pickling and rolling, so that partial dissolution of actomyosin is achieved, the meat becomes relatively compact, and the flavor is improved. Convenience is provided for solving the texture problems of poor chewability and poor viscoelasticity of aquatic meat products.

(3) According to the combined restructuring processing technology used in the present disclosure, a biological enzyme and a natural small-molecule substance are used for combination, so that reagents are green, safe, and environmentally friendly. The protease changes structural properties by acting on a peptide bond in a protein, and the natural small-molecule substance improves functional properties by crosslinking with a protein molecule. Through the combination of the two substances, restructuring of a protein is achieved, and the texture of a final product is improved. The natural small-molecule substance has excellent oxidation resistance, and can effectively improve the oxidation stability of meat products and prolong the shelf life of the meat products, thus having a broad market prospect.

(4) The protein combined restructured meat prepared by the present disclosure contains two proteins including an animal protein and a plant protein, and has a protein content of greater than 20%, so that resources are fully utilized. While the demands for nutritional dietary proteins are met, the chewability is greater than 1,500 g·mm, and the viscoelasticity is excellent. The meat can be processed in various shapes according to needs, directly heated for eating, or processed into a prepared food, a semi-finished product and the like, so that the product has a large application space.

### BRIEF DESCRIPTION OF FIGURES

FIG. 1 is a diagram showing a process flow of an aquatic-plant protein combined restructured meat prepared by the present disclosure.

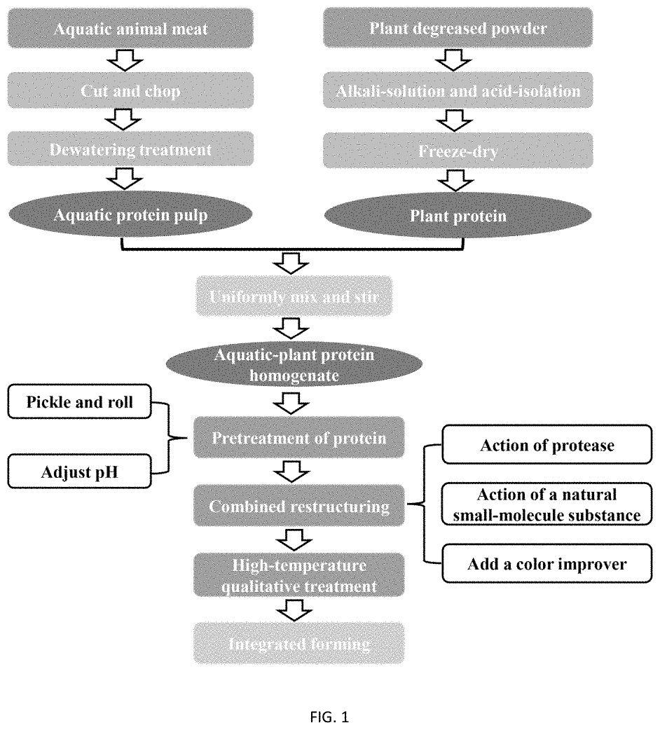

### DETAILED DESCRIPTION

The following examples are used to illustrate the present disclosure, rather than to limit the scope of the present disclosure. All modifications or substitutions of the method, steps or conditions of the present disclosure made without departing from the spirit and essence of the present disclosure shall fall within the scope of the present disclosure.

Unless particularly specified, experimental materials, reagents, instruments and the like used in the examples of the present disclosure are commercially available. Unless specifically specified, technical means used in the examples are conventional means well known to persons skilled in the art.

Test methods in the following examples:

Protein content: The protein content is determined by an automatic Kjeldahl apparatus.

1) 0.50-1.00 g of a sample was weighed and placed in a digestion flask, two tablets made of copper sulfate and potassium sulfate were added, and 10 ml of concentrated sulfuric acid was added. The digestion flask was placed in a digestion furnace, and then connected and sealed with a connection tube. An air pumping device was started, and a power supply of the digestion furnace was turned on. After a digestion solution was completely clarified and turned into bluish green, digestion was conducted for 30 min until the sample was completely digested.

2) The digestion flask was taken out and transferred into an automatic Kjeldahl apparatus, and relevant procedures, such as alkali addition, water addition, and distillation time, were set.

3) After a start key was pressed, distillation titration was automatically completed by the apparatus, and the results were displayed.

4) A digestion tube was taken out and cleanly rinsed for use in the next time.

Full-texture test: A P20 cylindrical probe with the cross-sectional area greater than the area of a sample was selected. The running track of the probe was as follows: the probe was started in the form of auto-20 g and compressed to the test sample at a pre-test rate of 2 mm/s from a starting position; after touching the surface of the sample, the probe was compressed to the sample at a test rate of 2 mm/s with a compression ratio of 30%; and after returning to a compression trigger point and waiting for an interval of 5 s, the probe was continuously compressed down for the same distance at a rate of 2 mm/s and then returned to the position before the test at a post-test rate of 5 mm/s.

Elasticity is expressed by the height at which the sample recovers after first compression.

Hardness is expressed by the force at which the maximum degree of compression is reached in a first compression process.

Cohesiveness is expressed by the ratio of the peak area in a second compression process to the peak area in the first compression process.

Adhesion is expressed by the negative peak area in a first ascending process.

Recoverability is expressed by the ratio of the peak area in the first ascending process to the peak area in a descending process.

Chewability is expressed by hardness*cohesiveness*elasticity.

### Example 1

(1) Preparation of an aquatic protein: 500 g of frozen basa fish slices were defrosted at low temperature, cut and chopped into evenly diced meats with a size of about 0.8 cm, and soaked and cleaned in 0.6% baking soda for 8 min to obtain a meat pulp. The meat pulp was treated with a dewatering machine to remove free water, and then a protein pulp was obtained.

(2) Preparation of a plant protein: Soybeans were crushed and sifted, and n-hexane accounting for 4 times the volume of the soybeans was added for degreasing. A degreased soybean powder was resuspended in deionized water. Next, the pH of an obtained solution was adjusted to 9.0 with sodium hydroxide, stirring was conducted at a constant temperature of 30° C. for 2 h, centrifugation was conducted to obtain a supernatant, and the pH was adjusted to 4.0 with hydrochloric acid. The above steps were repeated for 2 times. Then, centrifugation was conducted at 8,000 rpm for 15 min, and a protein precipitate was collected and washed with deionized water until the pH was neutral. Finally, freeze-drying was conducted to obtain a soybean protein isolate.

(3) Uniform mixing and stirring: The aquatic protein pulp obtained in step (1) and a soybean protein powder obtained in step (2) were mixed and stirred at a mass ratio of 10:1 at 4° C. for 25 min until a homogeneous state was reached, and then a protein homogenate was obtained.

(4) Pretreatment of a protein: A complex salt (including NaCl and phosphate) was added to the protein homogenate obtained in step (3) for pickling and rolling for 50 min, where the added amount of the NaCl was controlled to be 0.8 wt % of the weight of the protein homogenate, and the added amount of the phosphate (consisting of sodium pyrophosphate, sodium tripolyphosphate and sodium hexametaphosphate at a mass ratio of 3:5:1) was 0.4 wt % of the weight of the protein homogenate. Then food-grade sodium lactate was added for adjusting the pH to 7.5 so as to form a meat paste, and a paste protein was obtained.

(5) Combined restructuring: 1.0 wt % of glutamine transaminase and 0.10 wt % of epigallocatechin gallate (EGCG) were added to the paste protein obtained in step (4) for uniform mixing. Next, 0.35 wt ‰ of monascus red (which was purchased from a local supermarket in Wuxi, and has a CAS Number of 874807-57-5) was added for uniform stirring. Then, incubation was conducted in a water bath at 50° C. for 120 min to obtain a protein combined restructured meat, where the glutamine transaminase had an enzyme activity of 10 units/mg.

(6) High-temperature qualitative treatment: The protein combined restructured meat obtained in step (5) was subjected to inactivation and qualitative treatment in a high-temperature water bath at 90° C. for 10 min, and then cooling was conducted rapidly to room temperature to obtain an aquatic-plant protein combined restructured meat sample.

(7) Integrated forming: The aquatic-plant protein combined restructured meat sample obtained in step (6) was directly kneaded in the shape of a meat pie.

The aquatic-plant protein combined restructured meat prepared in Example 1 has high protein content, good color and lustre, moderately soft and hard taste, good elasticity, good chewability, obvious fleshy taste, good flavor and no obvious fishy taste.

### Example 2

With reference to Example 1, the difference was only that the soybeans in step (2) were separately substituted with mung beans, peas, black beans, kidney beans, and chickpeas. Results of properties of obtained aquatic-plant protein combined restructured meats were as shown in Table 1.

TABLE 1
Comparison table of properties of aquatic-plant protein combined
restructured meats prepared with different plant proteins

| | Protein | | | | | | |
|---|---|---|---|---|---|---|---|
| Plant | content | Elasticity | Hardness | | | Adhesion | Chewability |
| protein | (%) | (mm) | (g) | Cohesiveness | Recoverability | (J) | (g · mm) |
| Soybeans | 22 | 0.754 | 3150.487 | 0.76 | 0.348 | −18.329 | 1805.355 |
| Mung beans | 21 | 0.745 | 3268.147 | 0.68 | 0.315 | −20.249 | 1655.643 |
| Peas | 19 | 0.716 | 3045.896 | 0.65 | 0.327 | −19.863 | 1417.560 |
| Black beans | 17 | 0.734 | 2968.721 | 0.71 | 0.298 | −17.548 | 1547.119 |
| Kidney beans | 18 | 0.689 | 3054.762 | 0.59 | 0.259 | −16.982 | 1241.791 |
| Chickpeas | 20 | 0.74 | 3348.146 | 0.61 | 0.264 | −16.254 | 1511.353 |

From the data in Table 1, it can be seen that the type of the plant protein has little influence on the protein content of a product, but has certain influence on the texture and taste of the product, and the soybean protein has the best effect.

### Example 3

With reference to Example 1, the difference was only that the glutamine transaminase (TG enzyme) in step (5) was separately substituted with papain, bromerain, and flavourzyme. Results of properties of obtained aquatic-plant protein combined restructured meats were as shown in Table 2.

TABLE 2
Comparison table of properties of aquatic-plant protein combined restructured
meats prepared after treatment with different enzymes

| | Protein | | | | | | |
|---|---|---|---|---|---|---|---|
| | content | Elasticity | Hardness | | | Adhesion | Chewability |
| Protease | (%) | (mm) | (g) | Cohesiveness | Recoverability | (J) | (g · mm) |
| TG enzyme | 22 | 0.754 | 3150.487 | 0.76 | 0.348 | −18.329 | 1805.355 |
| Papain | 16 | 0.647 | 3215.468 | 0.68 | 0.315 | −15.146 | 1414.677 |
| Bromerain | 14 | 0.568 | 3048.853 | 0.72 | 0.287 | −12.864 | 1246.859 |
| Flavourzyme | 18 | 0.698 | 2959.487 | 0.61 | 0.296 | −14.437 | 1260.090 |

From the data in Table 2, it can be seen that the type of the protease has certain influence on the protein content, texture and taste of a product, and the glutamine transaminase (TG enzyme) has the best effect.

### Example 4

With reference to Example 1, the difference was only that the epigallocatechin gallate (EGCG) in step (5) was separately substituted with genipine, resveratrol, curcumin, and rosmarinic acid. Results of properties of obtained aquatic-plant protein combined restructured meats were as shown in Table 3.

TABLE 3
Comparison table of properties of aquatic-plant protein combined restructured
meats prepared with different natural small molecules

| | Protein | | | | | | |
|---|---|---|---|---|---|---|---|
| | content | Elasticity | Hardness | | | Adhesion | Chewability |
| Protease | (%) | (mm) | (g) | Cohesiveness | Recoverability | (J) | (g · mm) |
| EGCG | 22 | 0.754 | 3150.487 | 0.76 | 0.348 | −18.329 | 1805.355 |
| Genipine | 20 | 0.742 | 3058.465 | 0.65 | 0.315 | −19.543 | 1475.098 |
| Resveratrol | 19 | 0.716 | 3287.914 | 0.71 | 0.321 | −17.425 | 1671.444 |
| Curcumin | 18 | 0.782 | 3398.147 | 0.59 | 0.285 | −16.527 | 1567.837 |
| Rosmarinic | 17 | 0.705 | 3008.698 | 0.68 | 0.294 | −19.613 | 1442.370 |
| acid | | | | | | | |

From the data in Table 3, it can be seen that the type of the natural small molecule has little influence on the protein content of a product, but has certain influence on the texture and taste of the product, and the EGCG has the best effect.

### Example 5

With reference to Example 1, the difference was only that the mixing ratio of the aquatic protein pulp to the soybean protein powder in step (3) was separately changed into 30:1, 20:1, 5:1, and 1:1 Results of properties of obtained aquatic-plant protein combined restructured meats were as shown in Table 4.

TABLE 4
Comparison table of properties of aquatic-plant protein combined
restructured meats prepared at different protein mixing ratios

| | Protein | | | | | | |
|---|---|---|---|---|---|---|---|
| Mixing | content | Elasticity | Hardness | | | Adhesion | Chewability |
| ratio | (%) | (mm) | (g) | Cohesiveness | Recoverability | (J) | (g · mm) |
| 30:1 | 17 | 0.564 | 3285.198 | 0.58 | 0.283 | −14.285 | 1074.654 |
| 20:1 | 19 | 0.688 | 3195.487 | 0.69 | 0.301 | −16.358 | 1516.962 |
| 10:1 | 22 | 0.754 | 3150.487 | 0.76 | 0.348 | −18.329 | 1805.355 |
| 5:1 | 28 | 0.675 | 2898.583 | 0.61 | 0.215 | −14.527 | 1193.492 |
| 1:1 | 53 | 0.614 | 2248.942 | 0.46 | 0.186 | −10.591 | 635.1912 |

From the data in Table 4, it can be seen that when the mixing ratio of the aquatic protein pulp to the soybean protein powder is lower, a product has higher protein content, and when the ratio is 10:1, the product has the best texture and taste.

### Example 6

With reference to Example 1, the difference was only that the use amount of the glutamine transaminase in step (5) was separately changed into 0.2%, 0.5%, 1.0%, 2.0%, and 4.0%. Results of properties of aquatic-plant protein combined restructured meats obtained were as shown in Table 5.

TABLE 5
Comparison table of properties of aquatic-plant protein combined restructured
meats prepared with different use mounts of TG enzyme

| | Protein | | | | | | |
|---|---|---|---|---|---|---|---|
| Use | content | Elasticity | Hardness | | | Adhesion | Chewability |
| amount/% | (%) | (mm) | (g) | Cohesiveness | Recoverability | (J) | (g · mm) |
| 0.2 | 24 | 0.705 | 3021.046 | 0.68 | 0.288 | −14.587 | 1448.289 |
| 0.5 | 23 | 0.728 | 3047.345 | 0.73 | 0.312 | −16.458 | 1619.481 |
| 1.0 | 22 | 0.754 | 3150.487 | 0.76 | 0.348 | −18.329 | 1805.355 |
| 2.0 | 20 | 0.748 | 2987.465 | 0.67 | 0.334 | −19.618 | 1497.198 |
| 4.0 | 19 | 0.719 | 2876.423 | 0.61 | 0.316 | −20.247 | 1261.570 |

From the data in Table 5, it can be seen that the use amount of the glutamine transaminase has little influence on the protein content of a product, and when the use amount of the glutamine transaminase is 1.0%, the product has the best texture and taste.

### Example 7

With reference to Example 1, the difference was only that the use amount of the epigallocatechin gallate (EGCG) in step (5) was separately changed into 0.02%, 0.05%, 0.10%, 0.15%, and 0.20%. Results of properties of aquatic-plant protein combined restructured meats obtained were as shown in Table 6.

TABLE 6
Comparison table of properties of aquatic-plant protein combined
restructured meats prepared with different use mounts of EGCG

| | Protein | | | | | | |
|---|---|---|---|---|---|---|---|
| Use | content | Elasticity | Hardness | | | Adhesion | Chewability |
| amount/% | (%) | (mm) | (g) | Cohesiveness | Recoverability | (J) | (g · mm) |
| 0.02 | 20 | 0.684 | 2674.656 | 0.61 | 0.308 | −15.421 | 1115.973 |
| 0.05 | 21 | 0.724 | 2924.688 | 0.68 | 0.317 | −17.873 | 1439.882 |
| 0.10 | 22 | 0.754 | 3150.487 | 0.76 | 0.348 | −18.329 | 1805.355 |
| 0.15 | 23 | 0.741 | 3038.216 | 0.72 | 0.329 | −19.145 | 1620.949 |
| 0.20 | 22 | 0.694 | 2817.492 | 0.65 | 0.289 | −19.692 | 1270.971 |

From the data in Table 6, it can be seen that the use amount of the epigallocatechin gallate (EGCG) has little influence on the protein content of a product, but has certain influence on the texture and taste of the product, and when the use amount of the epigallocatechin gallate is 0.1%, the product has the best texture and taste.

### Comparative Example 1

With reference to the method in Example 1, raw materials were prepared. 500 g of frozen basa fish slices were defrosted at low temperature, and the defrosted meat slices were directly chopped in the shape of a meat pie.

### Comparative Example 2

With reference to Example 1, the difference was only that the soybeans were not additionally added. Specific operation steps were as follows.

(1) Preparation of an aquatic protein: 500 g of frozen basa fish slices were defrosted at low temperature, cut and chopped into evenly diced meats with a size of about 0.8 cm, and soaked and cleaned in 0.6% baking soda for 8 min to obtain a meat pulp. The meat pulp was treated with a centrifuge to remove free water, and then a protein pulp was obtained.

(4) Pretreatment of a protein: A complex salt was added to the obtained protein pulp for pickling and rolling for 50 min, where the added amount of NaCl was controlled to be 0.8% of the weight of a protein homogenate, and the added amount of phosphate was 0.4% of the weight of a protein homogenate. Then food-grade sodium lactate was added for adjusting the pH to 7.5 so as to form a meat paste.

(5) Forming and coloring: 1.3% of glutamine transaminase and 0.10% of epigallocatechin gallate (EGCG) were added to a paste protein obtained in the above step for uniform mixing. Next, 0.35‰ of monascus red was added for uniform stirring. Then, incubation was conducted in a water bath at 50° C. for 120 min.

(6) High-temperature qualitative treatment: A protein combined restructured meat obtained was subjected to inactivation and qualitative treatment in a high-temperature water bath at 90° C. for 10 min, and then cooling was conducted rapidly to room temperature in an ice bath.

(7) Integrated forming: A protein combined restructured meat sample obtained was directly kneaded in the shape of a meat pie.

### Comparative Example 3

With reference to Example 1, the differences were only that the EGCG was omitted in step (5), and only the glutamine transaminase was added. Specific steps were as follows.

(1) Preparation of an aquatic protein: 500 g of frozen basa fish slices were defrosted at low temperature, cut and chopped into evenly diced meats with a size of about 0.8 cm, and soaked and cleaned in 0.6% baking soda for 8 min to obtain a meat pulp. The meat pulp was treated with a centrifuge to remove free water, and then a protein pulp was obtained.

(2) Preparation of a plant protein: Soybeans were crushed and sifted, and n-hexane accounting for 4 times the volume of the soybeans was added for degreasing. A degreased soybean powder was resuspended in deionized water. Next, the pH of an obtained solution was adjusted to 9.0 with sodium hydroxide, stirring was conducted at a constant temperature of 30° C. for 2 h, centrifugation was conducted to obtain a supernatant, and the pH was adjusted to 4.0 with hydrochloric acid. The above steps were repeated for 2 times. Then, centrifugation was conducted at 8,000 rpm for 15 min, and a protein precipitate was collected and washed with deionized water until the pH was neutral. Finally, freeze-drying was conducted to obtain a soybean protein isolate.

(3) Uniform mixing and stirring: The aquatic protein pulp obtained in step (1) and a soybean protein powder obtained in step (2) were mixed and stirred at a ratio of 10:1 at 4° C. for 25 min until a homogeneous state was reached.

(4) Pretreatment of a protein: A complex salt was added to a protein homogenate obtained in step (3) for pickling and rolling for 50 min, where the added amount of NaCl was controlled to be 0.8% of the weight of the protein homogenate, and the added amount of phosphate was 0.4% of the weight of the protein homogenate. Then food-grade sodium lactate was added for adjusting the pH to 7.5 so as to form a meat paste.

(5) Combined restructuring: 1.3% of glutamine transaminase and 0.35% of monascus red were added to a paste protein obtained in step (4) for uniform stirring. Then, incubation was conducted in a water bath at 50° C. for 120 min.

(6) High-temperature qualitative treatment: A protein combined restructured meat obtained in step (5) was subjected to inactivation and qualitative treatment in a high-temperature water bath at 90° C. for 10 min, and then cooling was conducted rapidly to room temperature in an ice bath.

(7) Integrated forming: A protein combined restructured meat sample obtained in step (6) was directly kneaded in the shape of a meat pie.

### Comparative Example 4

With reference to Example 1, the differences were only that the protease in step (5) was omitted, and only the EGCG was added. Specific steps were as follows.

(1) Preparation of an aquatic protein: 500 g of frozen basa fish slices were defrosted at low temperature, cut and chopped into evenly diced meats with a size of about 0.8 cm, and soaked and cleaned in 0.6% baking soda for 8 min to obtain a meat pulp. The meat pulp was treated with a centrifuge to remove free water, and then a protein pulp was obtained.

(2) Preparation of a plant protein: Soybeans were crushed and sifted, and n-hexane accounting for 4 times the volume of the soybeans was added for degreasing. A degreased soybean powder was resuspended in deionized water. Next, the pH of an obtained solution was adjusted to 9.0 with sodium hydroxide, stirring was conducted at a constant temperature of 30° C. for 2 h, centrifugation was conducted to obtain a supernatant, and the pH was adjusted to 4.0 with hydrochloric acid. The above steps were repeated for 2 times. Then, centrifugation was conducted at 8,000 rpm for 15 min, and a protein precipitate was collected and washed with deionized water until the pH was neutral. Finally, freeze-drying was conducted to obtain a soybean protein isolate.

(3) Uniform mixing and stirring: The aquatic protein pulp obtained in step (1) and a soybean protein powder obtained in step (2) were mixed and stirred at a ratio of 10:1 at 4° C. for 25 min until a homogeneous state was reached.

(4) Pretreatment of a protein: A complex salt was added to a protein homogenate obtained in step (3) for pickling and rolling for 50 min, where the added amount of NaCl was controlled to be 0.8% of the weight of the protein homogenate, and the added amount of phosphate was 0.4% of the weight of the protein homogenate. Then food-grade sodium lactate was added for adjusting the pH to 7.5 so as to form a meat paste.

(5) Combined restructuring: 0.10% of epigallocatechin gallate (EGCG) and 0.35% of monascus red were added to a paste protein obtained in step (4) for uniform stirring. Then, incubation was conducted in a water bath at 50° C. for 120 min.

(6) Integrated forming: A protein combined restructured meat sample obtained in step (5) was directly kneaded in the shape of a meat pie.

Properties of products obtained in Comparative Examples 1-4 were determined. Results were as shown in Table 7.

TABLE 7
Comparison table of properties of samples in various comparative examples

| Samples | | | | | | | |
|---|---|---|---|---|---|---|---|
| with | | | | | | | |
| physical | | | | | | | |
| property | | | | | | | |
| data in | Protein | | | | | | |
| comparative | content | Elasticity | Hardness | | | Adhesion | Chewability |
| examples | (%) | (mm) | (g) | Cohesiveness | Recoverability | (J) | (g · mm) |
| Example 1 | 22 | 0.754 | 3150.487 | 0.76 | 0.348 | −18.329 | 1805.355 |
| Comparative | 12 | 0.571 | 2059.133 | 0.39 | 0.125 | −32.837 | 458.548 |
| Example 1 | | | | | | | |
| Comparative | 15 | 0.613 | 2249.867 | 0.44 | 0.187 | −29.782 | 606.834 |
| Example 2 | | | | | | | |
| Comparative | 20 | 0.718 | 2956.852 | 0.68 | 0.284 | −22.846 | 1443.653 |
| Example 3 | | | | | | | |
| Comparative | 23 | 0.688 | 2657.423 | 0.53 | 0.208 | −25.465 | 940.834 |
| Example 4 | | | | | | | |

From the results in Table 7, it is seen that the untreated aquatic protein meat (in Comparative Example 1) has low texture properties such as protein content, elasticity, hardness and cohesiveness, and poor chewability. The restructured meat (in Comparative Example 2) obtained after treatment by a protein processing technology has increased protein content, and the texture properties are also improved to a certain extent. However, the protein combined restructured meat (in Example 1) obtained after a plant protein is added has higher protein content, the texture properties are significantly improved, and the chewability is good.

Through comparison between Comparative Example 3 and Comparative Example 4, it is seen that both the EGCG and the glutamine transaminase are beneficial to the improvement of protein structures. When only the EGCG is added, the effect is poor (in Comparative Example 4). When only the glutamine transaminase is used, a certain effect is achieved (in Comparative Example 3). When the two substances are used for combination (in Example 1), properties of the restructured meat are greatly improved.

Although the present disclosure has been disclosed as preferred examples above, the preferred examples are not intended to limit the present disclosure. Various changes and modifications can be made by any person familiar with the technology without departing from the spirit and scope of the present disclosure. Therefore, the protection scope of the present disclosure shall be as defined in the claims.

What is claimed is:

1. A preparation method of an aquatic-plant protein combined restructured meat, comprising the following steps:
(1) preparation of an aquatic protein: defrosting an aquatic animal meat slice, conducting cutting and chopping, conducting soaking and cleaning in baking soda to obtain a meat pulp, and dewatering the meat pulp with a physical field to obtain an aquatic protein pulp;
(2) preparation of a plant protein: weighing a plant protein powder accounting for 5%-15% of the mass of the aquatic protein pulp obtained in step (1);
(3) uniform mixing and stirring: conducting mixing and stirring on the aquatic protein pulp obtained in step (1) and the plant protein powder obtained in step (2) until a homogeneous state is reached, and then obtaining a protein homogenate;
(4) pretreatment of a protein: adding a complex salt to the protein homogenate obtained in step (3) for pickling and rolling, adding a food-grade acid-base regulator for adjusting the pH so as to form a paste protein, and then obtaining the paste protein;
(5) combined restructuring: adding protease to the paste protein obtained in step (4), adding a natural small-molecule substance for crosslinking and restructuring of a protein, adding a color improver at the same time, conducting uniform mixing and stirring, and then conducting incubation in a water bath, wherein the natural small-molecule substance is epigallocatechin gallate (EGCG);
(6) high-temperature qualitative treatment: subjecting a product obtained in step (5) to inactivation and qualitative treatment in a high-temperature water bath, and then conducting cooling rapidly to room temperature; and
(7) integrated forming: conducting press forming on a sample obtained in step (6), or directly kneading the sample in the shape of a desired product to obtain the aquatic-plant protein combined restructured meat.

2. The method according to claim 1, wherein in step (2), the plant protein powder is derived from one of soybeans, peas, black beans, mung beans, kidney beans, and chickpeas.

3. The method according to claim 1, wherein in step (3), the mixing mass ratio of the aquatic protein pulp to the plant protein is 30:1 to 1:1.

4. The method according to claim 1, wherein in step (4), the complex salt is a complex of NaCl and phosphate, the added amount of the NaCl is controlled to be 0.5-1.5 wt % of the weight of the protein homogenate, and the added amount of the phosphate is 0-0.7 wt % of the weight of the protein homogenate.

5. The method according to claim 1, wherein in step (5), the protease is one of glutamine transaminase, papain, bromerain, and flavourzyme.

6. The method according to claim 1, wherein in step (5), the protease accounts for 0.2-4.0 wt % of the weight of the paste protein.

7. The method according to claim 1, wherein in (5), the added amount of the natural small-molecule substance is 0.02-0.20 wt % of the weight of the paste protein.

8. An aquatic-plant protein combined restructured meat prepared by the method according to claim 1.

9. A health food containing the aquatic-plant protein combined restructured meat according to claim 8.
